(19) United States
(12) Patent Application Publication
(10) Pub. No.: US 2025/0389691 A1
(43) Pub. Date: Dec. 25, 2025

(54) ELECTROCHEMICAL SENSOR CIRCUIT, ELECTROCHEMICAL SENSOR CIRCUIT FOR ODOR COMPONENT IDENTIFICATION, AND ODOR IDENTIFICATION SYSTEM

(71) Applicant: SONY SEMICONDUCTOR SOLUTIONS CORPORATION, KANAGAWA (JP)

(72) Inventors: YUSAKU SUGIMORI, KANAGAWA (JP); YURI KATO, KANAGAWA (JP)

(21) Appl. No.: 18/878,883

(22) PCT Filed: Jun. 8, 2023
(86) PCT No.: PCT/JP2023/021391

§ 371 Date: Dec. 25, 2024

(30) Foreign Application Priority Data
Jul. 12, 2022 (JP) 2022-111879

(51) Int. Cl. G01N 27/416

(52) U.S. Cl. CPC G01N 27/4166

(57) ABSTRACT

A technique capable of accurately identifying a chemical substance in a sample is provided. The present technology provides an electrochemical sensor circuit, or the like, including: at least two or more electrochemical sensor units connected to one AC signal generation unit; at least one or more response signal output circuits that output a response signal from the electrochemical sensor units; and an identification system unit that identifies a chemical substance in a sample on the basis of an output from the response signal output circuits.

### TECHNICAL FIELD

The present technology relates to an electrochemical sensor circuit, an electrochemical sensor circuit for odor component identification, and an odor identification system. More specifically, the present technology relates to an electrochemical sensor circuit, an electrochemical sensor circuit for odor component identification, and an odor identification system capable of accurately identifying a chemical substance in a sample.

### BACKGROUND ART

Electrochemical sensors are one of the most common sensors currently used in industry and are used in a wide range of applications such as gas detection, water quality test, bioanalysis, and food test. By using this type of sensor, it is possible to detect a chemical substance on the basis of an electronic parameter generated using an electrochemical reaction derived from a type, concentration, or the like, of the chemical substance.

In related art, a circuit using an electrochemical sensor for detecting a chemical substance has been proposed, and, for example, Patent Document 1 discloses a sensor interface circuit including an impedance characteristic sensor interface circuit that independently sends out a differential stable bias signal component and a differential time-varying AC excitation signal component that inspect impedance of an electrochemical sensor having a sensor input node, first and second differential sensor feedback nodes, and a sensor output node, the impedance characteristic sensor interface circuit including an impedance excitation amplifier circuit including a first differential input pair coupled to receive the differential time-varying AC excitation signal component for communicating with first and second amplifier input nodes during a sensor impedance inspection mode, and a second differential input pair coupled to receive the differential stable bias signal component for communicating with the first and second amplifier input nodes, and a third differential input pair coupled to receive a feedback signal from the differential sensor feedback nodes for communicating with the first and second amplifier input nodes, and a sensor response amplifier circuit coupled to the sensor for receiving a response signal to the differential time-varying AC excitation signal component for communicating with a sensor response signal output node during the sensor impedance inspection mode. In the sensor interface circuit, with a configuration in which a generated AC signal is applied to the electrochemical sensor that detects a gas, and a response signal to the AC signal is measured, change in the AC impedance of the electrochemical sensor can be detected by the response signal output circuit, an adsorption state of the gas can be determined.

### CITATION LIST

### Patent Document

Patent Document 1: Japanese Patent Application Laid-Open 2018-189651

### SUMMARY OF THE INVENTION

### Problems to be Solved by the Invention

However, in the circuit in the related art, only one electrochemical sensor is connected to one AC signal generation unit, and thus, only one-dimensional impedance change can be detected, and it is difficult to detect a chemical substance in a sample with high accuracy. In particular, this is remarkable in identification of a gas in which a plurality of components such as a gas containing an odor component is mixed.

It is therefore a main object of the present technology to provide a technology capable of accurately identifying a chemical substance in a sample.

### Solutions to Problems

The present technology first provides an electrochemical sensor circuit including at least two or more electrochemical sensor units connected to one AC signal generation unit, at least one or more response signal output circuits that output a response signal from the electrochemical sensor units, and an identification system unit that identifies a chemical substance in a sample on the basis of an output from the response signal output circuits.

Furthermore, the present technology also provides an electrochemical sensor circuit for odor component identification including at least two or more electrochemical sensor units connected to one AC signal generation unit, at least one or more response signal output circuits that output a response signal from the electrochemical sensor units, and an identification system unit that identifies an odor component in a sample on the basis of an output from the response signal output circuits.

Furthermore, the present technology also provides an odor identification system including an electrochemical sensor circuit for odor component identification including at least two or more electrochemical sensor units connected to one AC signal generation unit, at least one or more response signal output circuits that output a response signal from the electrochemical sensor units, and an identification system unit that identifies an odor component in a sample on the basis of an output from the response signal output circuits, and a cartridge including an odor holding portion that holds an odor component.

### BRIEF DESCRIPTION OF DRAWINGS

FIG. 1 is a circuit diagram illustrating a basic configuration of an electrochemical sensor circuit 1.

FIG. 2 is a view illustrating an example of a specific configuration of a response signal output circuit 13.

FIG. 3 is a view illustrating an example of a specific configuration of an identification system unit 14.

FIG. 4 is a view illustrating an example of a specific configuration of the identification system unit 14 different from that in FIG. 3.

FIG. 5 is a view illustrating an example of a specific configuration of the identification system unit 14 different from those in FIGS. 3 and 4.

FIG. 6 is a view illustrating an example of specific configurations of the identification system unit 14 and a sample generation unit 15.

FIG. 7 is a circuit diagram illustrating a configuration of circuit configuration example 1.

FIG. 8 is a circuit diagram illustrating a configuration of circuit configuration example 2.

FIG. 9 is a circuit diagram illustrating a configuration of circuit configuration example 3.

FIG. 10 is a circuit diagram illustrating a configuration of circuit configuration example 4.

FIG. 11 is a circuit diagram illustrating a configuration of circuit configuration example 5.

FIG. 12 is a circuit diagram illustrating a configuration of circuit configuration example 6.

FIG. 13 is a circuit diagram illustrating a configuration of circuit configuration example 7.

FIG. 14 is a circuit diagram illustrating a configuration of circuit configuration example 8.

FIG. 15 is a circuit diagram illustrating a configuration of circuit configuration example 9.

FIG. 16 is a circuit diagram illustrating a configuration of circuit configuration example 10.

FIG. 17 is a circuit diagram illustrating a configuration of circuit configuration example 11.

FIG. 18 is a perspective view illustrating an example of an embodiment of a cartridge 10.

FIG. 19 is a cross-sectional view of the cartridge 10 of the embodiment illustrated in FIG. 18.

FIG. 20 is a schematic diagram illustrating an example of an embodiment of an odor identification system 3.

### MODE FOR CARRYING OUT THE INVENTION

Hereinafter, preferred modes for carrying out the present technology will be described with reference to the drawings.

The embodiments to be described below are intended to illustrate examples of representative embodiments of the present technology, and the scope of the present technology will not be construed narrower by these embodiments. Note that the description will be made in the following order.
1. First Embodiment (Electrochemical Sensor Circuit 1)
(1) Basic Configuration of Electrochemical Sensor Circuit 1
(2) AC Signal Generation Unit 11
(3) Electrochemical Sensor Unit 12
(4) Response Signal Output Circuit 13
(5) Identification System Unit 14
(6) Sample Generation Unit 15
(7) Specific Configuration of Electrochemical Sensor Circuit 1
(7-1) Circuit Configuration Example 1
(7-2) Circuit Configuration Example 2
(7-3) Circuit Configuration Example 3
(7-4) Circuit Configuration Example 4
(7-5) Circuit Configuration Example 5
(7-6) Circuit Configuration Example 6
(7-7) Circuit Configuration Example 7
(7-8) Circuit Configuration Example 8
(7-9) Circuit Configuration Example 9
(7-10) Circuit Configuration Example 10
(7-11) Circuit Configuration Example 11
2. Second Embodiment (Electrochemical Sensor Circuit for Odor Component Identification 2)
3. Third Embodiment (Odor Identification System 3)
(1) Basic Configuration of Odor Identification System 3
(2) Electrochemical Sensor Circuit for Odor Component Identification 2
(3) Cartridge 10
(3-1) Odor Holding Portion 101
(3-2) Ventilation Portion 102
(3-3) Coupling Portion 103
(3-4) Discharge Portion 104
(3-5) Operation Example of Cartridge 10
(4) Sample Generation Unit 34
(4-1) Cartridge Holding Portion 31
(4-2) Front Surface Accommodation Portion 32
(4-3) Back Surface Accommodation Portion 33
(5) Application Example of Odor Identification System 3

### 1. First Embodiment (Electrochemical Sensor Circuit 1)

### (1) Basic Configuration of Electrochemical Sensor Circuit 1

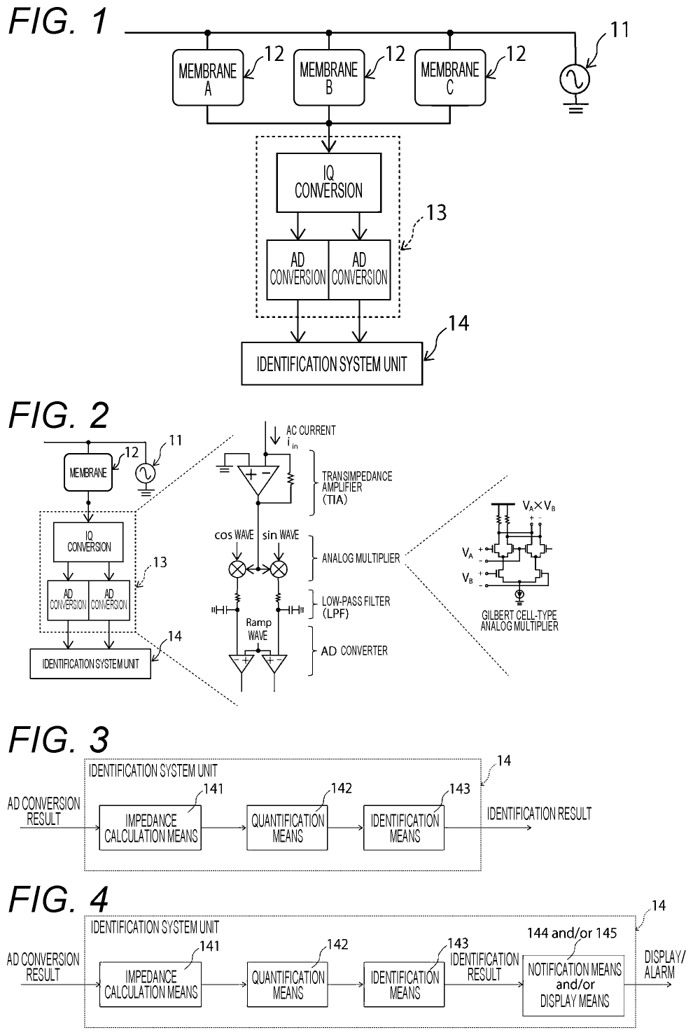

FIG. 1 is a circuit diagram illustrating a basic configuration of an electrochemical sensor circuit 1. The electrochemical sensor circuit 1 according to the present embodiment at least includes at least two or more electrochemical sensor units 12 connected to one AC signal generation unit 11, at least one or more response signal output circuits 13 that output a response signal from the electrochemical sensor units 12, and an identification system unit 14 that identifies a chemical substance in a sample on the basis of an output from response signal output circuits 13. In addition, the electrochemical sensor circuit 1 may include a sample generation unit 15, and the like, as necessary. Hereinafter, each unit of the electrochemical sensor circuit 1 will be described in detail.

### (2) AC Signal Generation Unit 11

The AC signal generation unit 11 generates an AC signal. In the present embodiment, a frequency of the AC signal generation unit 11 can be varied in an arbitrary range and used variably. As a result, for example, an AC signal can be applied at different frequencies for each of the electrochemical sensor units 12 described later. The frequency of the AC signal generation unit 11 is not particularly limited, and any frequency (for example, a range from 1 kHz to 10 MHz, or the like) can be used.

In the present embodiment, the frequency of the AC signal generation unit 11 may be controlled on the basis of an identification result of the identification system unit 14 as described later. Specific description will be made in “(7) Specific Configuration of Electrochemical Sensor Circuit 1”.

Furthermore, in the present embodiment, the number of the AC signal generation units 11 is not particularly limited as long as there are one or more AC signal generation units 11. In a case where there are two or more AC signal generation units 11, frequencies output from the respective AC signal generation units 11 may be the same, but some or all of them may be different.

In a case where there are two or more AC signal generation units 11, the AC signal generation units 11 having frequencies different for each row or column of the electrochemical sensor units 12 or some of the response signal output circuits 13 arranged in an array may be provided. Specific description will be made in “(7) Specific Configuration of Electrochemical Sensor Circuit 1”.

### (3) Electrochemical Sensor Unit 12

The electrochemical sensor unit 12 generates an electronic parameter (for example, a current, a voltage, capacity, impedance, or the like, preferably impedance), which is a response signal, using an electrochemical reaction derived from a type, concentration, or the like, of a chemical substance. In the present embodiment, the number of the electrochemical sensor units 12 is not particularly limited as long as at least two or more electrochemical sensor units 12 are connected to one AC signal generation unit 11.

In the present embodiment, as a result of at least two or more electrochemical sensor units 12 connected to one AC signal generation unit 11 being provided, a chemical substance in a sample can be identified with high accuracy. More specifically, measurement can be performed at an optimum frequency for each type and size of a membrane constituting the electrochemical sensor unit 12, and a gas in which a plurality of components such as a gas containing an odor component are mixed can be identified from a difference in a response signal caused by the type and the size of the membrane. In addition, area efficiency of a peripheral circuit is improved. Furthermore, by controlling driving of the AC signal generation unit 11, and the like, in accordance with an identification status, and the like, further improvement of the identification accuracy can be expected.

In the present specification, the “chemical substance” is an object to be identified contained in a sample and means any chemical substance such as a simple substance, a pure substance constituted with a compound, or a mixture. Further, the origin of the chemical substance is not particularly limited, and is not limited to natural origin, and the chemical substance may be artificially derived.

In the present specification, the “sample” means any sample including a biological sample. Furthermore, in the present technology, a state of the sample is not particularly limited, but is preferably any of a gas state, a liquid state, a semi-solid state, and a solid state, and is particularly preferably a gas state. Note that the term “gas” refers to a gas that is completely vaporized at normal temperature (25° C.). Further, the term “liquid” refers to a liquid that is completely liquefied at normal temperature. Further, the solid means a solid that is completely solidified at normal temperature. In addition, the semi-solid refers to one having a melting point of 25° C. or higher but not completely solidified at normal temperature. The chemical substance in the sample may be fixed to the sample by adhesion, adsorption, burying, or the like, or may float in the sample without being fixed.

The electrochemical sensor unit 12 is not particularly limited, and one known in related art can be used. Among electrochemical sensors known in the related art, an electrochemical sensor based on amperometry (that is, a current measurement sensor) is common. The electrochemical sensor based on amperometry basically has at least a working electrode, a counter electrode, and a reference electrode.

The working electrode is configured to cause an oxidation-reduction reaction on a surface of the working electrode when a predetermined voltage is applied to the working electrode with respect to the reference electrode by an electric circuit such as a potentiostat in a state where a sample exists between the working electrode and the counter electrode. More specifically, the working electrode includes a laminate including a membrane that causes an oxidation-reduction reaction of the chemical substance in the sample on the surface the working electrode when a predetermined voltage is applied between the working electrode and the counter electrode in a state where the sample is adhered, and a support member formed on one surface of the membrane.

In the present specification, the term “membrane” includes a membrane having any hardness, and both a very rigid membrane and a very flexible membrane are included in the term “membrane”. Examples of the membrane include a metal membrane of platinum, gold, or the like, membranes of graphite carbon, boron-doped diamond, etc., a polymer membrane formed with a conductive polymer such as polyaniline or polythiophene. The support member is preferably formed with a conductive material, and examples thereof include a silicon substrate and a metal substrate. Examples of the metal substrate include platinum (Pt), gold (Au), copper (Cu), palladium (Pd), nickel (Ni), and silver (Ag). In order to form the membrane on one surface of the support member, a metal membrane can be formed by sputtering, a gas phase synthesis method, or the like, and a polymer membrane can be formed by a method known in the related art such as chemical modification. In the present embodiment, a size (for example, several μm^{\hat{ }2} to several mm^{\hat{ }2}, and the like), an area, a thickness, and the like, of the membrane are not particularly limited.

The reference electrode and the counter electrode are provided in the vicinity of the working electrode, and the counter electrode is provided so as to surround the working electrode and the reference electrode. By applying a predetermined voltage between the working electrode and the counter electrode in a state where a chemical substance is adhered to the working electrode and the counter electrode, an oxidation-reduction reaction occurs at the working electrode and the counter electrode, whereby a current flows between the working electrode and the counter electrode. In other words, the counter electrode is an electrode for causing a current generated by an electrochemical reaction to flow through the working electrode.

As the counter electrode, for example, an electrode formed with a metal such as Pt, Au, Cu, Pd, Ni, or Ag, a diamond electrode, a boron-doped diamond electrode, a carbon electrode, or the like, can be used. The counter electrode can be formed using a method known in the related art such as a semi-additive method and a subtractive method.

The reference electrode is an electrode serving as a reference in determining a potential of the working electrode. As the reference electrode, for example, a silver/silver chloride (Ag/AgCl) electrode, or the like, can be used. In addition, a standard hydrogen electrode, a reversible hydrogen electrode, a palladium-hydrogen electrode, a saturated calomel electrode, a carbon electrode, a diamond electrode, a boron-doped diamond electrode, or the like, can be used. Furthermore, an electrode formed with a metal such as Pt, Au, Cu, Pd, Ni, or Ag may be used as the reference electrode. The reference electrode can be formed using a method known in the related art such as dispensing and screen printing.

In the present embodiment, at least some of the electrochemical sensor units 12 may be arranged in an array. Specific description will be made in “(7) Specific Configuration of Electrochemical Sensor Circuit 1”.

In the present embodiment, two or more electrochemical sensor units 12 may be of the same type, or may be of different types in part or in whole. In a case where two or more electrochemical sensor units 12 of the same type are arranged, two or more electrochemical sensor units 12 of the same type can be measured at different frequencies. Specific description will be made in “(7) Specific Configuration of Electrochemical Sensor Circuit 1”.

Furthermore, in the present embodiment, by configuring an electrochemical sensor group including two or more electrochemical sensor units 12 and providing a plurality of electrochemical sensor groups, measurement may be performed at different frequencies for each of the electrochemical sensor groups. Specific description will be made in “(7) Specific Configuration of Electrochemical Sensor Circuit 1”.

### (4) Response Signal Output Circuit 13

The response signal output circuit 13 outputs a response signal from the electrochemical sensor units 12. In the present embodiment, the number of the response signal output circuits 13 is not particularly limited as long as there are one or more response signal output circuits 13.

FIG. 2 is a view illustrating an example of a specific configuration of the response signal output circuit 13. The response signal output circuit 13 is not particularly limited, but at least some of the response signal output circuits 13 include an IQ conversion circuit and an AD conversion circuit. This can improve identification accuracy.

The IQ conversion circuit extends (converts) a target signal into a complex signal. Specifically, an I signal having the same phase (In-Phase) as the reference signal and a Q signal having a quadrature-phase shifted by 90° from the reference signal are generated. The IQ conversion circuit supplies the I signal and the Q signal to the AD conversion circuit.

More specifically, the IQ conversion circuit includes, for example, a transimpedance amplifier (TIA), an analog multiplier, and a low-pass filter (LPF). The TIA converts a current output from the electrochemical sensor unit 12 into a voltage signal. The converted voltage signal is calculated at high speed by the analog multiplier. The analog multiplier is not particularly limited, and an analog multiplier known in the related art can be used. Specifically, examples of the analog multiplier include a commonly used Gilbert cell-type analog multiplier. The LPF extracts a direct current (DC) component from a calculation result of the analog multiplier. DC components of the I signal and the Q signal correspond to a real component and an imaginary component of the input signal, and thus, an amplitude and a phase in the above-described electrochemical sensor unit 12 can be calculated, which results in making it possible to calculate impedance at a measurement point. The LPF is not particularly limited, and examples of the LPF include an RC low pass filter.

The AD conversion circuit converts the I signal and the Q signal in an analog format into signals in a digital format and supplies the signals to the identification system unit 14 described later. The AD conversion circuit is not particularly limited, and a single-slope AD converter known in the related art can be used. In the single-slope AD converter, an analog signal to be processed is converted into a digital signal on the basis of a period from start of conversion until a reference voltage matches a signal voltage to be processed. As a mechanism for this, for example, a comparator (voltage comparator) that compares a single-slope waveform with an output signal DC level of the IQ conversion circuit and a counter that measures a comparison period are used to supply a reference voltage and start counting with a clock signal at the same time, and AD conversion is performed by comparing the signal DC level output from the IQ conversion circuit with the reference voltage and counting until a pulse signal is obtained.

In the present embodiment, the AD conversion circuit may reduce noise by performing multi-sampling (a plurality of times of operation). This can improve identification accuracy.

Further, in the present embodiment, in the response signal output circuit 13, a circuit constant may be freely changed by changing a band to be cut by the LPF according to the type, the size, and the like, of the membrane constituting the electrochemical sensor unit 12. This can optimize the circuit constant according to the type, the size, and the like, of the membrane, and improve identification accuracy.

Furthermore, in the present embodiment, at least some of the response signal output circuits 13 may be arranged in an array. In addition, at least two or more of the electrochemical sensor units 12 may be connected to one response signal output circuit 13. Specific description will be made in “(7) Specific Configuration of Electrochemical Sensor Circuit 1”.

In addition, in the present embodiment, as described above, in a case where the frequency of the AC signal generation unit 11 is variably used, the response signal output circuit 13 may include two or more switches, and frequencies of the respective switches and the AC signal generation unit 11 may be controlled in accordance with the electrochemical sensor units 12. Specific description will be made in “(7) Specific Configuration of Electrochemical Sensor Circuit 1”.

### (5) Identification System Unit 14

The identification system unit 14 identifies a chemical substance in the sample on the basis of an output from the response signal output circuit 13. In the present embodiment, the number of the identification system units 14 is not particularly limited as long as there are one or more identification system units 14.

In the present embodiment, the identification system unit 14 may identify the chemical substance in the sample by checking the response signal for each electrochemical sensor unit 12 against a database. Specific description will be made in “(7) Specific Configuration of Electrochemical Sensor Circuit 1”.

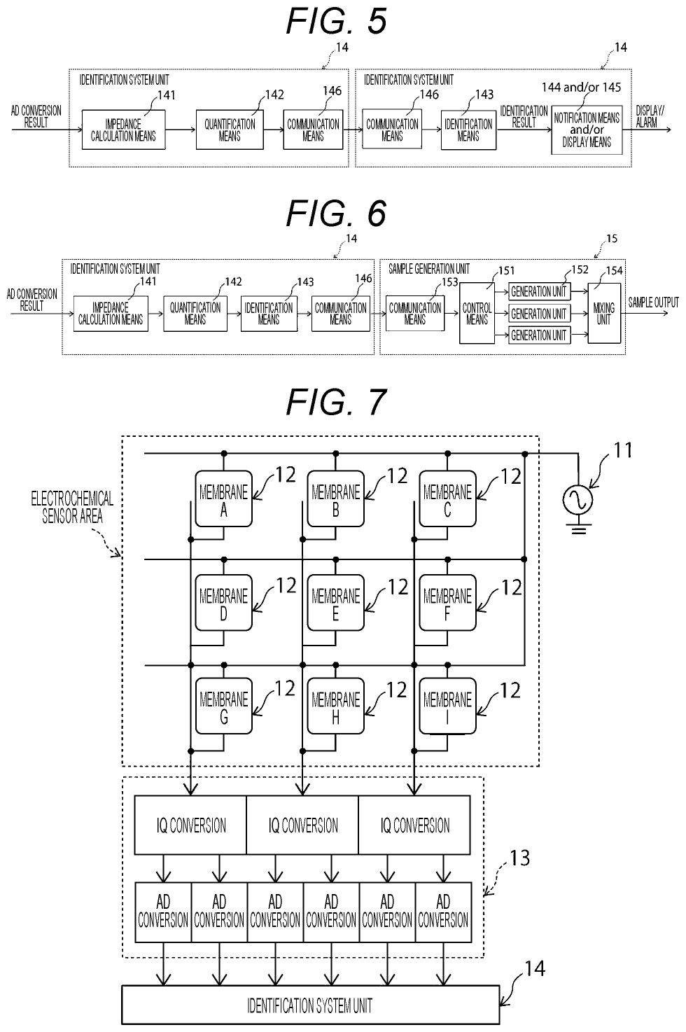

FIG. 3 is a view illustrating an example of a specific configuration of the identification system unit 14. The identification system unit 14 includes at least impedance calculation means 141, quantification means 142, and identification means 143. In addition, as illustrated in FIGS. 4 and 5, the identification system unit 14 may include notification means 144, display means 145, communication means 146, and the like, as necessary.

The impedance calculation means 141 calculates impedance on the basis of a digital signal output from the AD conversion circuits in the response signal output circuit 13. In the electrochemical sensor unit 12 described above, a value of the impedance, which is a response signal, of the electrochemical sensor units 12 changes depending on the type, concentration, and the like, of the chemical substance. Thus, the quantification means 142 quantifies the chemical substance in the sample on the basis of the calculated impedance result. In addition, the identification means 143 identifies the chemical substance in the sample on the basis of the quantified result of the chemical substance in the sample. For example, the identification of one or more chemical substances, the number of types of chemical substances, the concentration of chemical substances, and the like, are determined.

FIG. 4 is a view illustrating an example of a specific configuration of the identification system unit 14 different from that in FIG. 3. In the present embodiment, the identification system unit 14 may include the notification means 144 and/or the display means 145. The notification means 144 performs control to issue an alert for the purpose of calling attention, warning, or the like, on the basis of the identification result from the identification system unit 14. The display means 145 performs control to display the identification result from the identification system unit 14 on a display, a monitor, a smartphone, a tablet terminal, a wearable terminal, a digital signage, or the like. The electrochemical sensor circuit 1 has these means, so that it is possible to confirm data of the chemical substance identified on site.

FIG. 5 is a view illustrating an example of a specific configuration of the identification system unit 14 different from those in FIGS. 3 and 4. In the present embodiment, the identification system unit 14 includes communication means 146. For example, in a case where two or more communication means 146 are arranged between the quantification means 142 and the identification means 143, and these are connected in a wireless or wired manner, a signal related to a result of the remotely quantified chemical substance in the sample is acquired via a network, and the chemical substance in the sample is identified on the basis of the signal. This enables data of the identified chemical substance to be confirmed even at a remote location. Note that in the present embodiment, the communication means 146 may be arranged between the impedance calculation means 141 and the quantification means 142 or may be arranged between the identification means 143 and the notification means 144 and/or the display means 145.

### (6) Sample Generation Unit 15

The electrochemical sensor circuit 1 according to the present embodiment may include the sample generation unit 15 as necessary. The sample generation unit 15 generates a sample containing a chemical substance on the basis of the identification result of the identification system unit 14. Specifically, the sample generation unit 15 is connected to the identification system unit 14 in a wireless or wired manner and transmits a sample containing a chemical substance (in particular, odor components) to a target space by spraying, or the like, on the basis of the identification result output from the identification system unit 14. In the present embodiment, two or more sample generation units 15 may be provided, and the number of the sample generation units 15 is not particularly limited.

FIG. 6 is a view illustrating an example of specific configurations of the identification system unit 14 and the sample generation unit 15. The sample generation unit 15 includes at least control means 151 and a generation unit 152. Furthermore, the sample generation unit 15 may include communication means 153, a mixing unit 154, and the like, as necessary.

The control means 151 determines the type, concentration, and the like, of one or more chemical substances to be generated in the target space on the basis of a signal indicating the identification result acquired from the identification system unit 14. The type, concentration, and the like, of the chemical substance in the sample to be generated may be the same as the identification result or may be newly prepared on the basis of the identification result. Furthermore, in a case where the type, concentration, and the like, are newly prepared, the control means 151 may refer to a database on a network such as a server or a cloud system.

The generation unit 152 generates a sample in the target space on the basis of the type, concentration, and the like, of the chemical substance determined by the control means 151. In this event, the sample may be in any state of a gas, a liquid, a semi-solid, and a solid, but the sample is particularly preferably a gas. In addition, the generation unit 152 may control intensity of generation of the sample in the target space, and for example, in a case where the chemical substance is present at a concentration equal to or higher than a preset threshold, the generation unit 152 can weaken the generation of the sample or stop the generation of the sample. Furthermore, the generation unit 152 may change intensity of the generation of the sample over time.

In the present embodiment, as illustrated in FIG. 6, there may be two or more generation units 152. In this case, samples containing the same chemical substance may be generated from each generation unit 152, or samples containing different chemical substances may be generated from some or all of the generation units 152.

In a case where the sample generation unit 15 and the identification system unit 14 are connected in a wireless or wired manner, the communication means 153 remotely acquires a signal indicating the identification result via a network. This makes it possible to generate a sample containing a chemical substance at a remote location on the basis of the identification result of the identification system unit 14.

Note that, in the present embodiment, the communication means 153 is not an essential component, and even in a case where the communication means 153 is not provided, a sample containing a chemical substance identified on site can be generated.

In a case where there are two or more generation units 152, the mixing unit 154 mixes the samples from the respective generation units 152 at an arbitrary ratio. This makes it possible to generate a mixed sample obtained by mixing samples containing chemical substances in the target space. In addition, the mixing unit 154 may control intensity of generation of the mixed sample in the target space and may change the ratio over time when the samples from the respective generation units 152 are mixed.

### (7) Specific Configuration of Electrochemical Sensor Circuit 1

A specific configuration of the electrochemical sensor circuit 1 according to the present embodiment will be described in detail below. Note that the numbers of the AC signal generation units 11, the electrochemical sensor units 12, the response signal output circuits 13 including the IQ conversion circuit and the AD conversion circuit, and the odor identification system units 14 in each circuit configuration example are merely an example, and the present embodiment is not limited thereto. In addition, membranes of two or more electrochemical sensor units 12 in each circuit configuration example are merely given different names for convenience, and all of the membranes may be of the same type, or some or all of the membranes may be of different types.

### (7-1) Circuit Configuration Example 1

FIG. 7 is a circuit diagram illustrating a configuration of circuit configuration example 1. In circuit configuration example 1, nine electrochemical sensor units 12 including membranes A to I are arranged in an array with respect to one AC signal generation unit 11. The response signal output circuits 13 are laid out in a column direction with respect to the electrochemical sensor units 12 arranged in an array. With such a circuit configuration, it is possible to improve layout efficiency and reduce an entire area of the electrochemical sensor circuit 1. Note that although not illustrated, in the present embodiment, the response signal output circuits 13 may be laid out in a row direction with respect to the electrochemical sensor units 12 arranged in an array.

### (7-2) Circuit Configuration Example 2

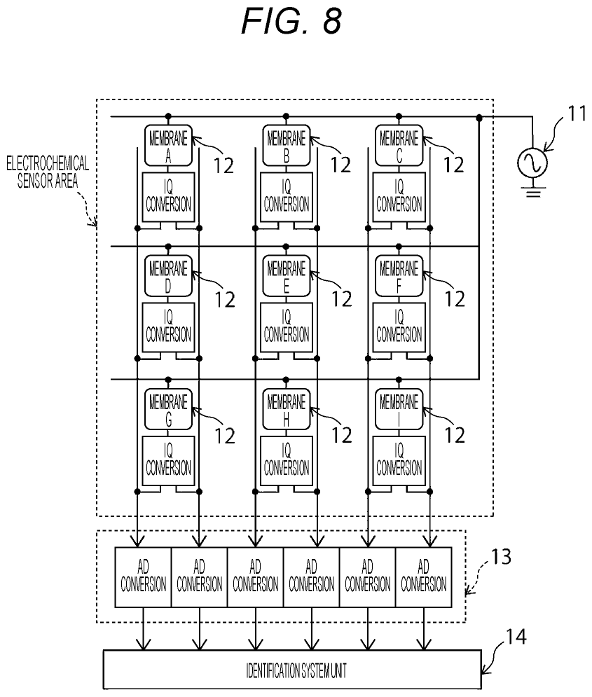

FIG. 8 is a circuit diagram illustrating a configuration of circuit configuration example 2. In circuit configuration example 2, there are nine electrochemical sensor units 12 including the membranes A to I with respect to one AC signal generation unit 11, and IQ conversion circuits constituting the response signal output circuit 13 are arranged in an array for each of the electrochemical sensor units 12. The AD conversion circuits constituting the response signal output circuit 13 are laid out in the column direction with respect to the IQ conversion circuits arranged in an array. With such a circuit configuration, it is possible to improve layout efficiency and reduce an entire area of the electrochemical sensor circuit 1. Note that although not illustrated, in the present embodiment, the AD conversion circuits may be laid out in the row direction with respect to the IQ conversion circuits arranged in an array.

### (7-3) Circuit Configuration Example 3

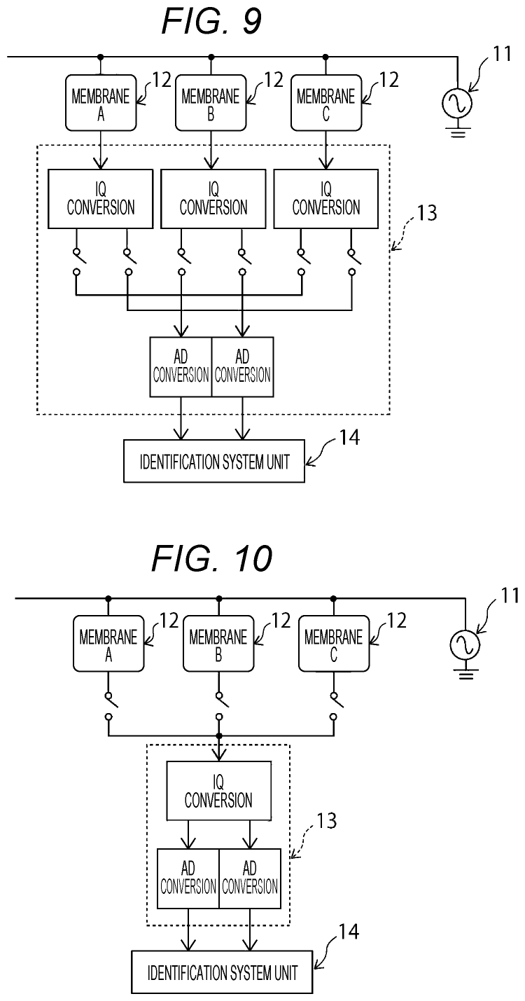

FIG. 9 is a circuit diagram illustrating a configuration of circuit configuration example 3. In circuit configuration example 3, there are three electrochemical sensor units 12 including the membranes A to C with respect to one AC signal generation unit 11, and each electrochemical sensor unit 12 is connected to the IQ conversion circuit. Further, two or more IQ conversion circuits are connected to one AD conversion circuit. In this case, a switch for controlling electrical connection may be provided between the AD conversion circuits and the IQ conversion circuits. Examples of the switch include a transistor, and the like. With such a circuit configuration, it is possible to reduce the number of the AD conversion circuits, improve layout efficiency and reduce an entire area of the electrochemical sensor circuit 1.

### (7-4) Circuit Configuration Example 4

FIG. 10 is a circuit diagram illustrating a configuration of circuit configuration example 4. In circuit configuration example 4, there are three electrochemical sensor units 12 including the membranes A to C with respect to one AC signal generation unit 11, and one response signal output circuit 13 is connected to each electrochemical sensor unit 12. In this case, a switch for controlling electrical connection may be provided between the IQ conversion circuit constituting the response signal output circuit 13 and the respective electrochemical sensor units 12. Examples of the switch include a transistor, and the like. With such a circuit configuration, it is possible to reduce the number of the response signal output circuits 13, improve layout efficiency and reduce an entire area of the electrochemical sensor circuit 1.

Further, in circuit configuration example 4, two or more electrochemical sensor units 12 connected to the response signal output circuit 13 may be of the same type. This makes it possible to adjust sensitivity of the electrochemical sensor unit 12.

### (7-5) Circuit Configuration Example 5

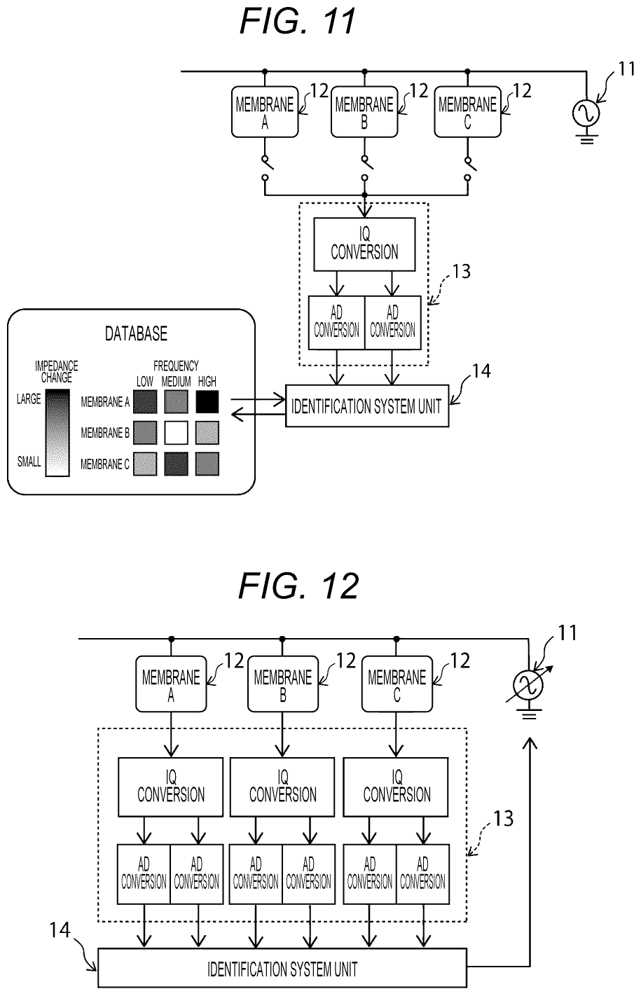

FIG. 11 is a circuit diagram illustrating a configuration of circuit configuration example 5. In circuit configuration example 5, components other than the identification system unit 14 are the same as those in circuit configuration example 4. In circuit configuration example 5, the identification system unit 14 identifies the chemical substance in the sample by checking the response signal of each of the electrochemical sensor units 12 against a database on a network such as a server or a cloud system. In this case, the database may be constructed by an AI learning method such as deep learning. This can improve identification accuracy.

### (7-6) Circuit Configuration Example 6

FIG. 12 is a circuit diagram illustrating a configuration of circuit configuration example 6. In circuit configuration example 6, there are three electrochemical sensor units 12 including the membranes A to C with respect to one AC signal generation unit 11, and each response signal output circuit 13 is connected to each electrochemical sensor unit 12. In circuit configuration example 6, a frequency of the AC signal generation unit 11 is variably used. With such a circuit configuration, it is possible to reduce the number of the AC signal generation units 11, improve layout efficiency and reduce an entire area of the electrochemical sensor circuit 1.

In addition, in circuit configuration example 6, the identification result of the identification system unit 14 may be fed back to control the frequency in the AC signal generation unit 11. This can improve identification accuracy and identification speed.

### (7-7) Circuit Configuration Example 7

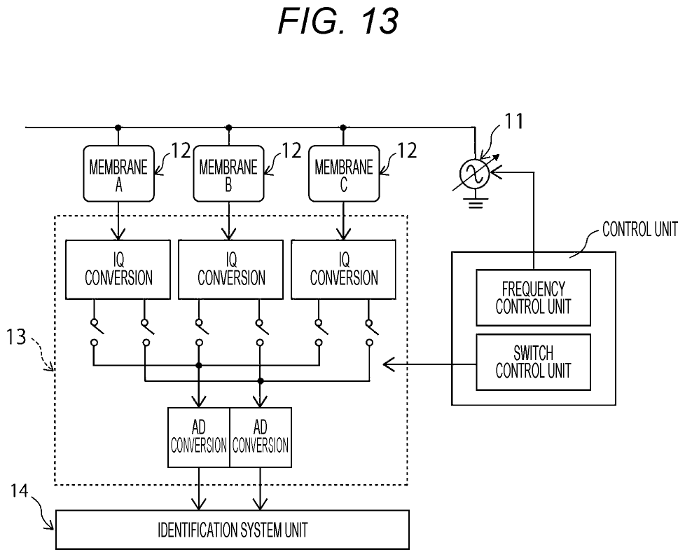

FIG. 13 is a circuit diagram illustrating a configuration of circuit configuration example 7. In circuit configuration example 7, there are three electrochemical sensor units 12 including the membranes A to C with respect to one AC signal generation unit 11, and the response signal output circuit 13 having a switch is connected to each of the electrochemical sensor units 12. In circuit configuration example 7, a frequency of the AC signal generation unit 11 is variably used, and a control unit including a frequency control unit and a switch control unit is provided. The control unit controls a frequency of each switch and the AC signal generation unit 11 in accordance with each electrochemical sensor unit 12 that measures an electrical parameter such as impedance. The frequency of the AC signal generation unit 11 can be controlled, for example, by changing the frequency to 100 KHz when the electrochemical sensor unit 12 constituted with the membrane A is read out. Examples of the switch include a transistor, and the like. With such a circuit configuration, it is possible to change a frequency to be observed in accordance with the type and the size of the membrane and identify the chemical substance in the sample while weighting the response signal for each frequency. In addition, it is possible to improve layout efficiency and reduce an entire area of the electrochemical sensor circuit 1.

### (7-8) Circuit Configuration Example 8

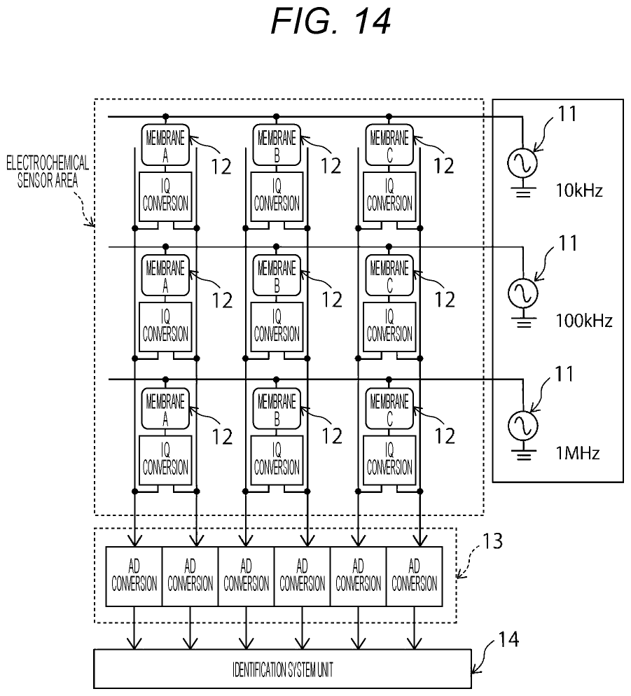

FIG. 14 is a circuit diagram illustrating a configuration of circuit configuration example 8. In circuit configuration example 8, components other than the AC signal generation unit 11 are the same as those in circuit configuration example 2. In circuit configuration example 8, three AC signal generation units 11 having different frequencies (for example, 10 kHz, 100 kHz, and 1 MHz) for each row are arranged. With such a circuit configuration, it is possible to increase reading speed. Note that although not illustrated, in the present embodiment, two or more AC signal generation units 11 having different frequencies for each column may be arranged.

Further, in circuit configuration example 8, two or more electrochemical sensor units 12 of the same type may be arranged, and two or more AC signal generation units 11 may measure electrochemical sensor units 12 at different frequencies.

### (7-9) Circuit Configuration Example 9

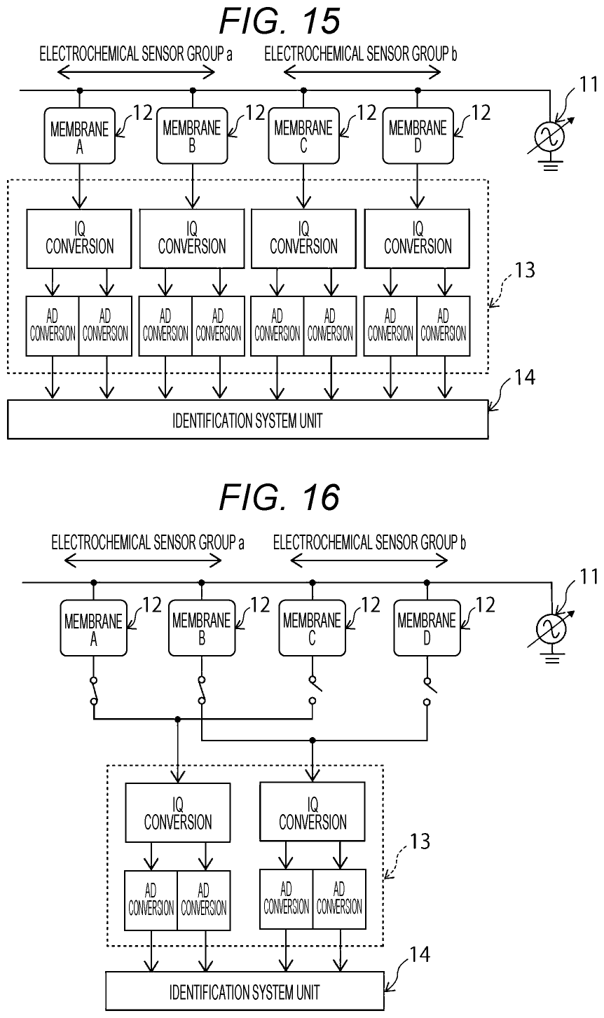

FIG. 15 is a circuit diagram illustrating a configuration of circuit configuration example 9. In circuit configuration example 9, there are an electrochemical sensor group a having two electrochemical sensor units 12 including membranes A and B, and an electrochemical sensor group b having two electrochemical sensor units 12 including membranes C and D. As described above, in circuit configuration example 9, a plurality of electrochemical sensor groups may be configured with two or more electrochemical sensor units 12 for which frequencies desired to be observed are close to each other, and measurement may be performed at different frequencies for each electrochemical sensor group. In circuit configuration example 9, the frequency of the AC signal generation unit 11 is variably used. For example, in a case where it is desired to read the electrochemical sensor group a at a low frequency and it is desired to read the electrochemical sensor group b at a high frequency, the frequency of the AC signal generation unit 11 can be changed and optimized for each electrochemical sensor group. With such a circuit configuration, it is possible to improve layout efficiency and reduce an entire area of the electrochemical sensor circuit 1.

### (7-10) Circuit Configuration Example 10

FIG. 16 is a circuit diagram illustrating a configuration of circuit configuration example 10. Circuit configuration example 10 is the same as circuit configuration example 9 in that the electrochemical sensor group a and the electrochemical sensor group b are provided, but the response signal output circuits 13 are shared across the electrochemical sensor groups. In this case, the response signal output circuits 13 shared by the electrochemical sensor groups may be connected by a switch. Examples of the switch include a transistor, and the like. With such a circuit configuration, it is possible to reduce the number of the response signal output circuits 13, improve layout efficiency and reduce an entire area of the electrochemical sensor circuit 1.

(7-11) Circuit Configuration Example 11

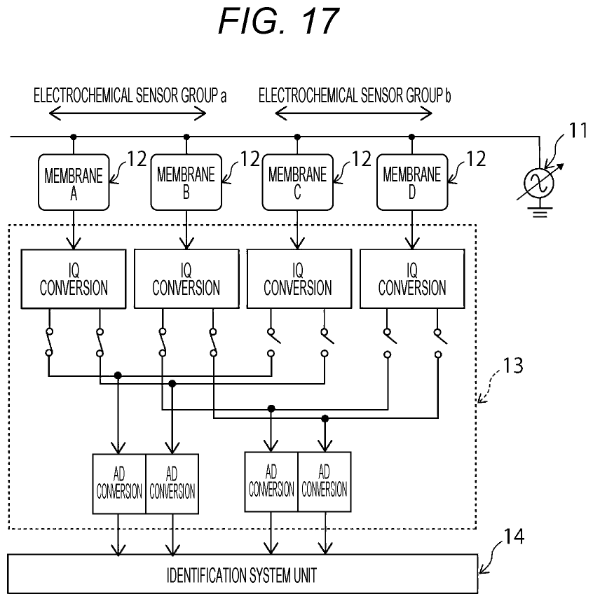

FIG. 17 is a circuit diagram illustrating a configuration of circuit configuration example 11. Circuit configuration example 11 is the same as circuit configuration examples 9 and 10 in that the electrochemical sensor group a and the electrochemical sensor group b are provided, but the AD conversion circuits that are part of the response signal output circuits 13 are shared across the electrochemical sensor groups. In this case, the AD conversion circuits shared by the electrochemical sensor groups may be connected by a switch. Examples of the switch include a transistor, and the like. With such a circuit configuration, it is possible to reduce the number of the AD conversion circuits, improve layout efficiency and reduce an entire area of the electrochemical sensor circuit 1.

### 2. Second Embodiment (Electrochemical Sensor Circuit for Odor Component Identification 2)

An electrochemical sensor circuit for odor component identification 2 according to the present embodiment at least includes at least two or more electrochemical sensor units 12 connected to one AC signal generation unit 11, at least one or more response signal output circuits 13 that output a response signal from the electrochemical sensor units 12, and the identification system unit 14 that identifies an odor component in a sample on the basis of an output from the response signal output circuits 13. In other words, the electrochemical sensor circuit 1 described above is applied to odor component identification, and the configuration of the electrochemical sensor circuit for odor component identification 2 is similar to that described above, and thus, the description thereof is omitted here.

In the present specification, the “odor component” may include any component that stimulates some or all of receptors present in the nasal cavity, such as odor molecules, among the above-described chemical substances. In the nasal cavity, besides olfactory receptors, receptors of the trigeminal nerve that control stimulation such as cold, hot, and pain exist, and the odor component in the present technology is broad concept including all components that stimulate some or all of these receptors. Specifically, for example, in a case where menthol is used as an odor component, menthol can serve as a stimulus through an olfactory receptor as well as a cold stimulus through a receptor of the trigeminal nerve (TRPA1 channel).

### 3. Third Embodiment (Odor Identification System 3)

### (1) Basic Configuration of Odor Identification System 3

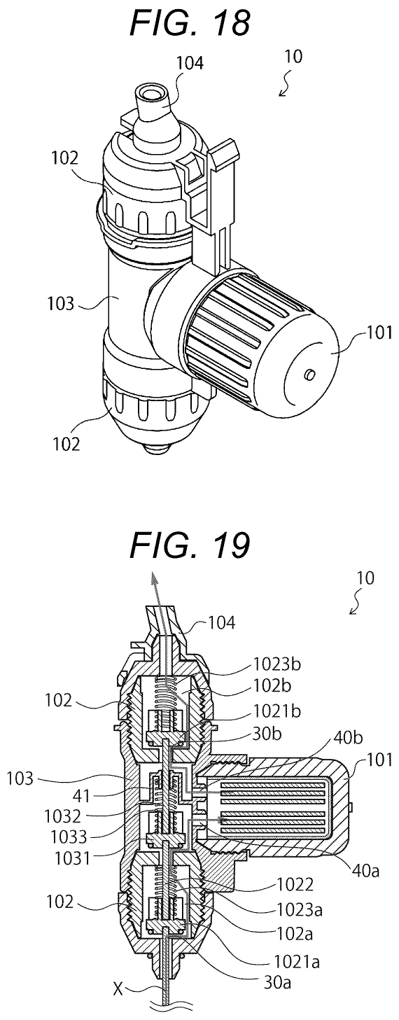

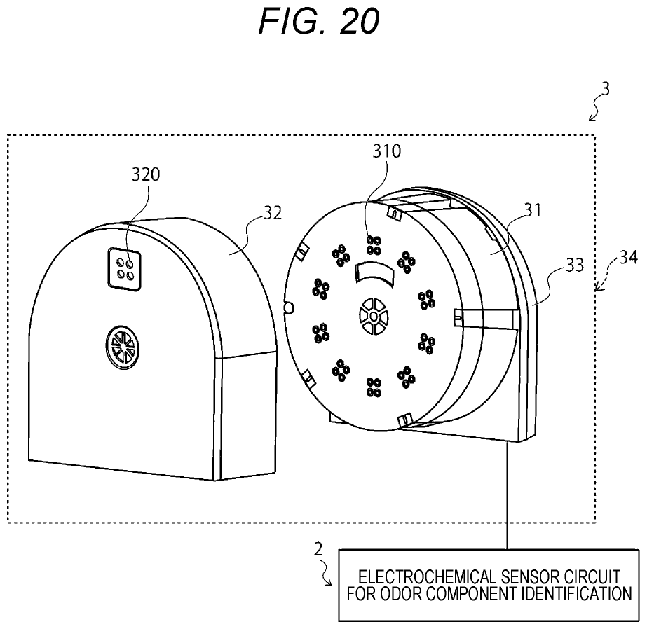

FIG. 20 is a schematic diagram illustrating an example of an embodiment of an odor identification system 3. The odor identification system 3 according to the present technology includes the above-described electrochemical sensor circuit for odor component identification 2 and the cartridge 10 (see FIG. 18) including the odor holding portion 101 that holds an odor component. In addition, the odor identification system 3 may include a sample generation unit 34, and the like, as necessary.

Each unit will be described in detail below.

### (2) Electrochemical Sensor Circuit for Odor Component Identification 2

The electrochemical sensor circuit for odor component identification 2 is similar to that described in “2. Second Embodiment (Electrochemical Sensor Circuit for Odor Component Identification 2)”, and thus, the description thereof is herein omitted.

### (3) Cartridge 10

FIG. 18 is a perspective view illustrating an example of an embodiment of the cartridge 10, and FIG. 19 is a cross-sectional view of the cartridge 10 of the embodiment illustrated in FIG. 18. As illustrated in FIG. 18, the cartridge 10 includes at least an odor holding portion 101 that holds an odor component. In addition, the cartridge 10 may include a ventilation portion 102, a coupling portion 103, a discharge portion 104, and the like, as necessary.

### (3-1) Odor Holding Portion 101

The odor holding portion 101 is a portion that holds an odor component, and includes, for example, an impregnating agent, a container portion that accommodates the impregnating agent, and a lid portion fitted to the container portion.

A material forming the impregnating agent is not particularly limited as long as it can hold the odor component, and is formed with, for example, an organic polymer material so that the odor component easily infiltrates. As the organic polymer material, for example, polyvinyl chloride, polyethylene, a phenol resin, an olefin resin, nylon, polyester, a synthetic rubber, a silicone resin, a natural rubber, a protein, a nucleic acid, a lipid, a polysaccharide, or the like, or one kind or two or more kinds thereof can be freely combined and used. In addition, for example, a polymer resin such as an acrylic resin, a urethane resin, an ABS resin, a polyether ether ketone (PEEK) resin, a polyacetal (POM) resin, a fluororesin, a cycloolefin polymer resin, or a polyimide resin may be used.; Metal such as stainless steel and aluminum; Inorganic crystals such as quartz, Glass, or the like, or one kind or two or more kinds thereof can be freely combined and used. In addition, the impregnating agent may be formed porous, and for example, a mesh structure, cork, mesoporous silica, calcium carbonate, or the like, can be used. Furthermore, the impregnating agent may be formed to have a fiber structure or a layered structure (for example, clay minerals, and the like).

A form of the impregnating agent is not particularly limited, and examples thereof include a sheet form, a mesh form, a strip form (including a dense body thereof), a particulate (including a dense body thereof), a gel form, a liquid form (including liquids maintained at surface tension, such as carriers), a foam form, a three-dimensional structure (for example, a fisheye shape, a spiral shape, a spring shape, and the like), a string form (including a dense body thereof), and the like. The odor component held in the impregnating agent is not particularly limited, and for example, as long as it is a component that generates an odor, such as a liquid perfume, a powder perfume, or the like, as it is, or a component obtained by dissolving or dispersing a liquid perfume, a powder perfume, or the like, in an appropriate solvent, an essential oil as it is or a component obtained by diluting an essential oil in an appropriate solvent, a fruit juice, a food or drink, or the like, as it is or a component obtained by dissolving or dispersing a fruit juice, a food or drink, or the like, in an appropriate solvent, or the like, one kind or two or more kinds thereof can be freely combined and used.

The container portion preferably has a two-layer structure, and includes, for example, an inner layer portion forming an inner side for holding the impregnating agent and an outer layer portion forming an outer side of the container portion. The lid portion preferably has an opening at a position corresponding to a coupling opening 40 (40a, 40b) to be described later. This results in making it possible to efficiently perform inflow of air into the container portion and discharge of air containing an odor component to the outside of the container portion.

### (3-2) Ventilation Portion 102

The ventilation portion 102 has at least a ventilation opening 30 that can be open and closed. For example, the ventilation portion 102 can be configured to be divided into two sections (a first ventilation portion 102a, a second ventilation portion 102b) by two ventilation openings 30 (30a, 30b). In the embodiment illustrated in FIGS. 18 and 19, the ventilation opening 30 includes an inflow ventilation opening 30a for allowing air to flow into the cartridge 10 and a discharge ventilation opening 30b for discharging air containing an odor component.

Further, an opening and closing mechanism can be connected to the ventilation opening 30 (30a, 30b). A specific structure of the opening and closing mechanism is not particularly limited as long as the ventilation opening 30 (30a, 30b) can be opened and closed, and can be freely designed. Specifically, for example, an opening and closing mechanism including a sealing lid 1021 (1021a, 1021b), a shaft 1022, and a spring 1023 (1023a, 1023b) may be provided.

The ventilation portion 102 preferably has a two-layer structure, and includes, for example, an inner layer member that stores the opening and closing mechanism and an outer layer member that forms the outer side of the ventilation portion 102.

### (3-3) Coupling Portion 103

The coupling portion 103 at least includes at least two coupling openings 40 (40a, 40b) that allow the ventilation portion 102 and the odor holding portion 101 to communicate with each other, and a partition portion 41 disposed upstream of one of the at least two coupling openings 40 (40a, 40b).

The two coupling openings 40 (40a, 40b) include a first coupling opening 40a that discharges air from the coupling portion 103 to the odor holding portion 101, and a second coupling opening 40b that discharges air containing an odor component from the odor holding portion 101 to the coupling portion 103. In this case, the air flowing into the coupling portion 103 via the first ventilation portion 102a is discharged to the odor holding portion 101 via the first coupling opening 40a and is mixed with the odor component, and thereafter, the air containing the odor component flows into the coupling portion 103 via the second coupling opening 40b and is discharged to the outside via the second ventilation portion 102b.

The partition portion 41 is disposed upstream of the second coupling opening 40b out of the two coupling openings 40 (40a, 40b). By providing the partition portion 41, the air flowing into the coupling portion 103 forcibly becomes the air containing the odor component via the odor holding portion 101 and flows into the coupling portion 103 again. As a result, the air containing the odor component can be efficiently generated.

In the embodiment illustrated in FIGS. 18 and 19, the coupling portion 103 may have an opening and closing mechanism in a connection region with the ventilation portion 102. Specifically, an opening and closing mechanism similar to the ventilation portion 102 can be used, and for example, an opening and closing mechanism including a sealing lid 1031, a shaft 1032, and a spring 1033 may be provided.

### (3-4) Discharge Portion 104

The discharge portion 104 has at least a nozzle structure capable of discharging the air containing the odor component to the outside and changing a direction of the air containing the odor component.

A form of the discharge portion 104 is not particularly limited, but for example, a cap that covers the outer layer member can be used, but the present embodiment is not limited thereto, and the outer layer member and the discharge portion 104 may be integrally formed.

### (3-5) Operation Example of Cartridge 10

Hereinafter, an operation example of discharging the air containing the odor component in the cartridge 10 will be described in detail.

In the embodiment illustrated in FIGS. 18 and 19, if the ventilation portion 102 is opened in a state where the odor component is held in the odor holding portion 101, air flows in from the outside. The introduced air flows into the coupling portion 103 and is mixed with the odor component through the one coupling opening 40a, and the air containing the odor component is discharged. In this state, the discharged air containing the odor component flows into the coupling portion 103 via the other coupling opening 40b, and is thereby discharged to the outside from the discharge portion 104.

Specifically, in the present embodiment, the ventilation opening 30 (30a, 30b) is provided with an opening and closing mechanism including the sealing lid 1021 (1021a, 1021b), the shaft 1022, and the spring 1023 (1023a, 1023b), and the coupling portion 103 is also provided with an opening and closing mechanism including the sealing lid 1031, the shaft 1032, and the spring 1033. These opening and closing mechanisms can be controlled, for example, by inserting a pusher X from the odor generation device side, or the like, from a lower portion of the cartridge 10. If the pusher X is pressed, the pusher X pushes the first sealing lid 1021a toward the inside of the first ventilation portion 102a, the inflow ventilation opening 30a is opened, and air flows into the first ventilation portion 102a. In this event, the first spring 1023a is contracted by the first sealing lid 1021a.

As a result of the first sealing lid 1021a being pushed in an inner direction of the first ventilation portion 102a, the shaft 1022 attached to the first sealing lid 1021a moves in a direction of the coupling portion 103. The shaft 1022 pushes the sealing lid 1031 toward the inside of the coupling portion 103, and the air in the first ventilation portion 102a flows into the coupling portion 103. In this event, the spring 1033 is contracted by the sealing lid 1031. By the partition portion 41, the air flowing into the coupling portion 103 first flows into the odor holding portion 101 through the first coupling opening 40a and is mixed with the odor component held in the odor holding portion 101, thereby air containing the odor component is generated. The air containing the odor component flows into the coupling portion 103 again through the second coupling opening 40b.

As a result of the sealing lid 1031 being pushed in an inner direction of the coupling portion 103, the shaft 1032 attached to the sealing lid 1031 moves in a direction of the second ventilation portion 102b. The shaft 1032 pushes the second sealing lid 1021b toward the inside of the second ventilation portion 102b, and the air containing the odor component in the coupling portion 103 flows into the second ventilation portion 102b. In this event, the second spring 1023b is contracted by the second sealing lid 1021b. In the present embodiment, the second ventilation portion 102b communicates with the discharge ventilation opening 30b, and thus, the air containing the odor component flowing into the second ventilation portion 102b flows into the discharge portion 104 through the discharge ventilation opening 30b and is discharged to the outside.

If the pressing to the pusher X is released after the air containing the odor component is discharged to the outside, the first sealing lid 1021a is returned to the original position by restoring force of the contracted first spring 1023a. In addition, the sealing lid 1031 is returned to the original position by restoring force of the spring 1033, and the second sealing lid 1021b is returned to the original position by restoring force of the second spring 1023b.

### (4) Sample Generation Unit 34

The sample generation unit 34 generates a sample containing a chemical substance on the basis of the identification result of the identification system unit. Specifically, the sample generation unit 34 may be similar to that described in “(6) Sample Generation Unit 15” in the first embodiment, and as described below, the sample generation unit 34 may be configured to include at least a cartridge holding portion 31, a front surface accommodation portion 32, and a back surface accommodation portion 33.

### (4-1) Cartridge Holding Portion 31

The cartridge holding portion 31 is a portion that holds one or two or more cartridges 10. The cartridge holding portion 31 includes, for example, an indwelling portion in which one or more cartridges 10 are indwelled and which has a discharge hole 310 for discharging the air containing the odor component discharged from the cartridge 10, and a holding portion which is fitted to the indwelling portion to hold the cartridge 10. Note that the number of cartridges 10 to be held by the cartridge holding portion 31 is not particularly limited, and can be freely set according to the application of the odor identification system 3.

Forms of the indwelling portion and the cartridge holding portion 31 are not particularly limited, and can be freely designed according to the form of the cartridge 10 to be held, and the like. For example, the indwelling portion and the cartridge holding portion 31 may be formed to have a substantially rectangular parallelepiped shape, a substantially cylindrical shape, a substantially cubic shape, or the like. Materials forming the indwelling portion and the cartridge holding portion 31 are not particularly limited as long as the cartridge 10 can be held, and examples thereof include the same materials as those listed as the materials of the impregnating agent.

### (4-2) Front Surface Accommodation Portion 32

The front surface accommodation portion 32 has at least a discharge hole 320 through which air containing an odor component is to be discharged to the outside. As illustrated in FIG. 20, the discharge hole 320 may be provided in part of the front surface accommodation portion 32, and in this case, the discharge hole may be communicable with the discharge hole of the indwelling portion.

In addition, the front surface accommodation portion 32 may include a guide portion (not illustrated) that guides the air containing the odor component in the vicinity of the nose of the user. A material forming the guide portion is not particularly limited, and for example, paper (including recycled paper), wood, bamboo sheath, plastic, coal, or the like, or one or a combination of two or more thereof can be used. Furthermore, part or all of the guide portion may be detachably formed, in which case, for example, the guide portion may be disposable for each user.

### (4-3) Back Surface Accommodation Portion 33

The back surface accommodation portion 33 includes at least a drive mechanism portion and an arrangement drive portion.

The drive mechanism portion includes a drive mechanism accommodation portion, and is connected to an operation shaft and the shaft 1022 in the cartridge 10 to drive them. The drive mechanism portion includes a pusher connected to the operation shaft and a shape memory alloy SMA of a thin wire which is a drive source for driving the pusher inside the drive mechanism accommodation portion. A rear end of the pusher is fixed to a drive mechanism fixing portion provided at the inner rear end of the drive mechanism accommodation portion. An SMA sliding portion for folding back and sliding the shape memory alloy SMA is provided near the distal end of the pusher. In addition, the entire drive mechanism portion is fixed by a support, or the like, attached below the drive mechanism accommodation portion, and a wiring capable of supplying power is connected to a rear end of the shape memory alloy SMA located in the drive mechanism fixing portion. The pusher is movable inside the drive mechanism accommodation portion in an extending direction by expansion and contraction of the shape memory alloy SMA.

The shape memory alloy SMA is folded back in a U-shape at the SMA sliding portion provided near the distal end of the pusher and passes through the inside of the pusher, and both ends thereof are fixed to the drive mechanism fixing portion located at the rear end of the pusher. Moreover, an actuator as the drive source is not limited to the shape memory alloy SMA, and may be, for example, a linear motion mechanism that linearly moves the pusher such as a motor, a solenoid, a linear slide type, a pneumatic (air pump type), or a small electromagnet. Here, the linear motion mechanism includes not only a case where one member moves in a linear direction but also a case where some of a plurality of members connected to each other move in the linear direction.

The arrangement drive portion arranges the specific cartridge 10 in the vicinity of the discharge hole 320 on the basis of the identification result of the identification system unit 14. The arrangement drive portion can be driven in conformity with the form of the cartridge holding portion 31, and the like, and can be driven to perform, for example, linear drive, XY axis drive, rotational drive, and the like. The actuator as the drive source may be an actuator known in the related art, and is not particularly limited in the present embodiment.

### (5) Application Example of Odor Identification System 3

The odor identification system 3 according to the present technology can be used, for example, as an application for discharging an odor in a limited target space. Specifically, the odor identification system 3 is used for an olfactory test, an olfactory training (including olfactory stimulation therapy) system, and the like. Note that, in the present specification, “olfactory training” is interpreted in a broad sense, and can include practice such as an odor judge test, a sommelier test, and an aromatherapy test.

Further, in recent years, it is known that olfactory dysfunction occurs prior to deterioration of cognitive function in a specific neurodegenerative disease. For example, it is known that in Alzheimer's dementia, deposition of amyloid β protein or phosphorylated tau protein in an olfactory related region is observed prior to atrophy of the hippocampus. Thus, the odor identification system 3 according to the present technology can also be used as a neurodegenerative disease prevention or treatment system.

Furthermore, the odor identification system 3 according to the present technology can be used as an odor experience and measurement system. Specifically, for example, the odor identification system 3 may be used for flavor simulation in development of food and drink. Further, the odor identification system 3 may be mounted on an automobile, head-mounted display, a relaxation product such as a neck pillow, an eye pillow, a sofa and a bed, and the like. Furthermore, the odor identification system 3 may be used for a halitosis checker, a body odor checker, an offensive odor investigation, an odor countermeasure, and the like.

In a case where the odor identification system 3 is mounted on an automobile, for example, an odor may be generated on the basis of an instruction of a driver or a passenger, or position information of the automobile, movement of the driver or the passenger, a biological signal, or the like, may be detected, and an odor may be generated on the basis of the detection result. In a case where the odor identification system 3 is mounted on a head-mounted display, for example, an odor may be generated in conjunction with an image presented on the display, or motion of a user, a biological signal, or the like, may be detected, and an odor may be generated on the basis of the detection result. In a case where the odor identification system 3 is mounted on a relaxation product, for example, an odor may be generated on the basis of an instruction of a user, or motion of the user, a biological signal, or the like, may be detected, and an odor may be generated on the basis of the detection result.

In addition, the odor identification system 3 according to the present technology can be used as an application for discharging an odor in a non-limitative wide range of target space. Specifically, the odor identification system 3 is used in an odor experience system mounted on a product attracting customers such as a vending machine, a digital signage, and a robot. In a case where the odor identification system 3 is mounted on a product attracting customers, for example, action, facial expression, and the like, of an unspecified number of users may be detected, and an odor may be generated on the basis of the detection result.

Note that the present technology can also adopt the following configurations.
[1]

An electrochemical sensor circuit including:

at least two or more electrochemical sensor units connected to one AC signal generation unit;

at least one or more response signal output circuits that output a response signal from the electrochemical sensor units; and

an identification system unit that identifies a chemical substance in a sample on the basis of an output from the response signal output circuits.
[2]

The electrochemical sensor circuit according to [1], in which at least some of the electrochemical sensor units are arranged in an array.
[3]

The electrochemical sensor circuit according to [2], in which at least some of the response signal output circuits are arranged in an array.
[4]

The electrochemical sensor circuit according to any one of [1] to [3], in which at least some of the response signal output circuits include an IQ conversion circuit and an AD conversion circuit.
[5]

The electrochemical sensor circuit according to any one of [1] to [4], in which at least two or more electrochemical sensor units are connected to one of the response signal output circuits.
[6]

The electrochemical sensor circuit according to any one of [1] to [5], in which the identification system unit identifies the chemical substance in the sample by checking a response signal of each electrochemical sensor unit against a database.
[7]

The electrochemical sensor circuit according to any one of [1] to [6], in which the identification system unit includes:

impedance calculation means that calculates impedance on the basis of an output result of the response signal output circuits;

quantification means that quantifies the chemical substance in the sample on the basis of a result of the impedance calculation means; and

identification means that identifies the chemical substance in the sample on the basis of a result of the quantification means.
[8]

The electrochemical sensor circuit according to any one of [1] to [7], further including a sample generation unit that generates a sample containing a chemical substance on the basis of an identification result of the identification system unit.
[9]

The electrochemical sensor circuit according to any one of [1] to [8], in which a frequency of the AC signal generation unit is variable.

The electrochemical sensor circuit according to any one of [1] to [9], in which a frequency of the AC signal generation unit is controlled on the basis of an identification result of the identification system unit.
[11]

The electrochemical sensor circuit according to [9], in which the response signal output circuit includes two or more switches, and

controls frequencies of the respective switches and the AC signal generation unit in accordance with the electrochemical sensor units.
[12]

The electrochemical sensor circuit according to [2] or [3], in which the AC signal generation units having frequencies different for each row or column are provided.
[13]

The electrochemical sensor circuit according to [12], in which two or more electrochemical sensor units of the same type are arranged, and

the two or more electrochemical sensor units of the same type are measured at different frequencies.
[14]

The electrochemical sensor circuit according to any one of [1] to [12], further including a plurality of electrochemical sensor groups each including at least two or more electrochemical sensor units, in which

measurement is performed at different frequencies for each of the electrochemical sensor groups.
[15]

The electrochemical sensor circuit according to any one of [1] to [14], in which the sample is in any one of a gas state, a liquid state, a semi-solid state, and a solid state.
[16]

An electrochemical sensor circuit for odor component identification, including:

at least two or more electrochemical sensor units connected to one AC signal generation unit;

at least one or more response signal output circuits that output a response signal from the electrochemical sensor units; and

an identification system unit that identifies an odor component in a sample on the basis of an output from the response signal output circuits.
[17]

An odor identification system including:

an electrochemical sensor circuit for odor component identification including at least two or more electrochemical sensor units connected to one AC signal generation unit, at least one or more response signal output circuits that output a response signal from the electrochemical sensor units, and an identification system unit that identifies an odor component in a sample on the basis of an output from the response signal output circuits; and

a cartridge including an odor holding portion that holds an odor component.
[18]

The odor identification system according to [17], further including a sample generation unit that generates a sample containing a chemical substance on the basis of an identification result of the identification system unit.
[19]

The odor identification system according to or [18],to be used in any one or more systems selected from the group consisting of an olfactory test or olfactory training system, a neurodegenerative disease prevention or treatment system, and an odor experience or measurement system.

### REFERENCE SIGNS LIST

1 Electrochemical sensor circuit
11 AC signal generation unit
12 Electrochemical sensor unit
13 Response signal output circuit
14 Identification system unit
15 Sample generation unit
2 Electrochemical sensor circuit for odor component identification
3 Odor identification system
10 Cartridge
101 Odor holding portion
102 Ventilation portion
103 Coupling portion
104 Discharge portion
31 Cartridge holding portion
32 Front surface accommodation portion
33 Back surface accommodation portion
34 Sample generation unit

1. An electrochemical sensor circuit comprising:
at least two or more electrochemical sensor units connected to one AC signal generation unit;
at least one or more response signal output circuits that output a response signal from the electrochemical sensor units; and
an identification system unit that identifies a chemical substance in a sample on a basis of an output from the response signal output circuits.

2. The electrochemical sensor circuit according to claim 1, wherein at least some of the electrochemical sensor units are arranged in an array.

3. The electrochemical sensor circuit of claim 2, wherein at least some of the response signal output circuits are arranged in an array.

4. The electrochemical sensor circuit according to claim 1, wherein at least some of the response signal output circuits include an IQ conversion circuit and an AD conversion circuit.

5. The electrochemical sensor circuit according to claim 1, wherein at least two or more electrochemical sensor units are connected to one of the response signal output circuits.

6. The electrochemical sensor circuit according to claim 1, wherein the identification system unit identifies the chemical substance in the sample by checking a response signal for each electrochemical sensor unit against a database.

7. The electrochemical sensor circuit according to claim 1, wherein the identification system unit includes
impedance calculation means that calculates an impedance on a basis of an output result of the response signal output circuits;
quantification means that quantifies the chemical substance in the sample on a basis of a result of the impedance calculation means; and
identification means that identifies the chemical substance in the sample on a basis of a result of the quantification means.

8. The electrochemical sensor circuit according to claim 1, further comprising a sample generation unit that generates a sample containing a chemical substance on a basis of an identification result of the identification system unit.

9. The electrochemical sensor circuit according to claim 1, wherein a frequency of the AC signal generation unit is variable.

10. The electrochemical sensor circuit according to claim 1, wherein a frequency of the AC signal generation unit is controlled on a basis of an identification result of the identification system unit.

11. The electrochemical sensor circuit according to claim 9, wherein the response signal output circuit includes two or more switches, and
controls frequencies of the respective switches and the AC signal generation units in accordance with the electrochemical sensor units.

12. The electrochemical sensor circuit according to claim 2, wherein the AC signal generation units having frequencies different for each row or column are provided.

13. The electrochemical sensor circuit according to claim 12, wherein two or more electrochemical sensor units of the same type are arranged, and
the two or more electrochemical sensor units of the same type are measured at different frequencies.

14. The electrochemical sensor circuit according to claim 1, further comprising a plurality of electrochemical sensor groups each including at least two or more electrochemical sensor units, wherein
measurement is performed at different frequencies for each of the electrochemical sensor groups.

15. The electrochemical sensor circuit according to claim 1, wherein the sample is in any one of a gas state, a liquid state, a semi-solid state, and a solid state.

16. An electrochemical sensor circuit for odor component identification, comprising:
at least two or more electrochemical sensor units each connected to one AC signal generation unit;
at least one or more response signal output circuits that output a response signal from the electrochemical sensor units; and
an identification system unit that identifies an odor component in a sample on a basis of an output from the response signal output circuits.

17. An odor identification system comprising:
an electrochemical sensor circuit for odor component identification including at least two or more electrochemical sensor units connected to one AC signal generation unit, at least one or more response signal output circuits that output a response signal from the electrochemical sensor units, and an identification system unit that identifies an odor component in a sample on a basis of an output from the response signal output circuits; and
a cartridge including an odor holding portion that holds an odor component.

18. The odor identification system according to claim 17, further comprising a sample generation unit that generates a sample containing a chemical substance on a basis of an identification result of the identification system unit.

19. The odor identification system according to claim 17, wherein the odor identification system is used in any one or more systems selected from the group consisting of an olfactory test or olfactory training system, a neurodegenerative disease prevention or treatment system, and an odor experience or measurement system.
